(19) United States
(12) Patent Application Publication
(10) Pub. No.: US 2024/0251360 A1
(43) Pub. Date: Jul. 25, 2024

(54) RELAYING POWER TO DEVICE NODES

(71) Applicant: Hewlett-Packard Development Company, L.P., Spring, TX (US)

(72) Inventors: Tyler SIMS, Corvallis, OR (US); William ALLEN, Corvallis, OR (US); Qiwei WANG, Palo Alto, CA (US)

(21) Appl. No.: 18/560,856

(22) PCT Filed: May 24, 2021
(86) PCT No.: PCT/US2021/033911

§ 371 Date: Nov. 14, 2023

(51) Int. Cl. H04W 52/40; H04B 7/04; H04W 84/18

(52) U.S. Cl. CPC H04W 52/40; H04B 7/04013; H04W 84/18

(57) ABSTRACT

In one example, a method of relaying energy to device nodes is disclosed. The method includes transmitting energy waves into an aggregated node group with multiple device nodes. The transmitted energy waves are to actuate the device nodes into a higher power state and in part for storage by the device nodes. Energy streams reflected by the aggregated node group may be captured to indicate actuated and non-actuated device nodes. The method determines a target low power state device node from the non-actuated low power state device nodes and determine neighboring higher power state device nodes proximate to the target low power state device node. A communication signal may be transmitted to the neighboring higher power state device nodes directing them to relay the stored energy to the target low power state device node to actuate the target low power state device node into a higher power state.

### BACKGROUND

Asset visibility systems Often utilize embedded devices to locate, trace, and do machine learning and data collection on assets. Such systems find use in inventory control management, loss prevention, etc. An asset visibility system may include a large number of nodes that are embedded or placed on the Packaging, or asset to be managed. The nodes may be disposed within a mesh network and may communicate with each other to facilitate asset visibility.

### BRIEF DESCRIPTION OF THE DRAWINGS

FIG. 1 illustrates an example visibility management system according to the present disclosure.

FIG. 2 illustrates another example visibility management system according to the present disclosure.

FIG. 3 illustrates a method for dynamically managing device power states according to an example of the present disclosure.

FIG. 4 illustrates an example mesh topology of the visibility management system of FIG. 2.

FIG. 5 illustrates a computer system architecture suitable for implementing examples or components to manage power states of aggregated node groups of the present disclosure.

FIG. 6 illustrates a system for relaying energy between device nodes of an aggregated node group according to an example of the present disclosure.

FIG. 7 illustrates an aggregate node group having a non-actuated inner node that can be actuated to a higher power state according to an example of the present disclosure.

FIG. 8 illustrates a method of relaying energy to an example device node according to an example of the present disclosure.

FIG. 9A illustrates example instructions stored on a non-transitory computer-readable storage medium to relay energy to device nodes according to the present disclosure.

FIG. 9B illustrates an example computing device according to the present disclosure.

### DETAILED DESCRIPTION

As noted above, embedded nodes for asset visibility may form a mesh network. The effectiveness and reliability of the mesh network may depend upon whether the embedded nodes can be toggled into a higher power state. For example, such higher power states can facilitate asset location information exchange. In this higher power state, among other functionalities, the embedded device nodes are awake and can communicate with other neighboring device nodes. As another example, the embedded nodes may have added functional capabilities for computing, enhanced communications, location, and learning.

When exposed to direct energy from a reflective energy device (RED) such as a broadband phased radar array, the embedded nodes can be toggled into the higher functioning state. However, embedded nodes that are in heavily dampened, or shielded zones, such as the center of a pallet of liquid goods, are unable to receive direct energy from REDs. Thus, any such node would remain in a perpetual low power state, may fail, resulting in asset loss, and considerably impacting the effectiveness and reliability of any associated asset visibility system.

Accordingly, the present disclosure addresses the foregoing by disclosing a method of relaying energy to a device node such as one that is in a heavily dampened or shielded zone of a pallet. In an example of the present disclosure, the method includes transmitting energy waves into an aggregated node group that has a plurality of device nodes. The transmitted energy waves may actuate the device nodes into a higher power state and are in part for storage by the device nodes.

In one example, the method may capture energy streams reflected by the aggregated node group to indicate which actuated device nodes in the higher power state and non-actuated low power state device nodes. In some examples, the reflected energy streams (broadband, multi modal) may create a 3D image volume may be a 3D image volume of the aggregated node group that displays both the actuated and the non-actuated device nodes. In this manner, the entirety of an aggregated node group volume can be visible.

In some examples, the method may determine a target low power state device node from the non-actuated low power state device nodes and determine neighboring higher power state device nodes that are proximate to the target low power state device node. The method may then transmit a communication signal to the neighboring higher power state device nodes.

The communication signal may direct the neighboring higher power state device nodes to relay the stored energy to the target low power state device node to actuate the target low power state device node into a higher power state. In this manner, no device node remains in a perpetual low power state, and device failure and asset losses associated with failed devices can be avoided. Consequently, the effectiveness and reliability of any associated asset visibility system is greatly increased.

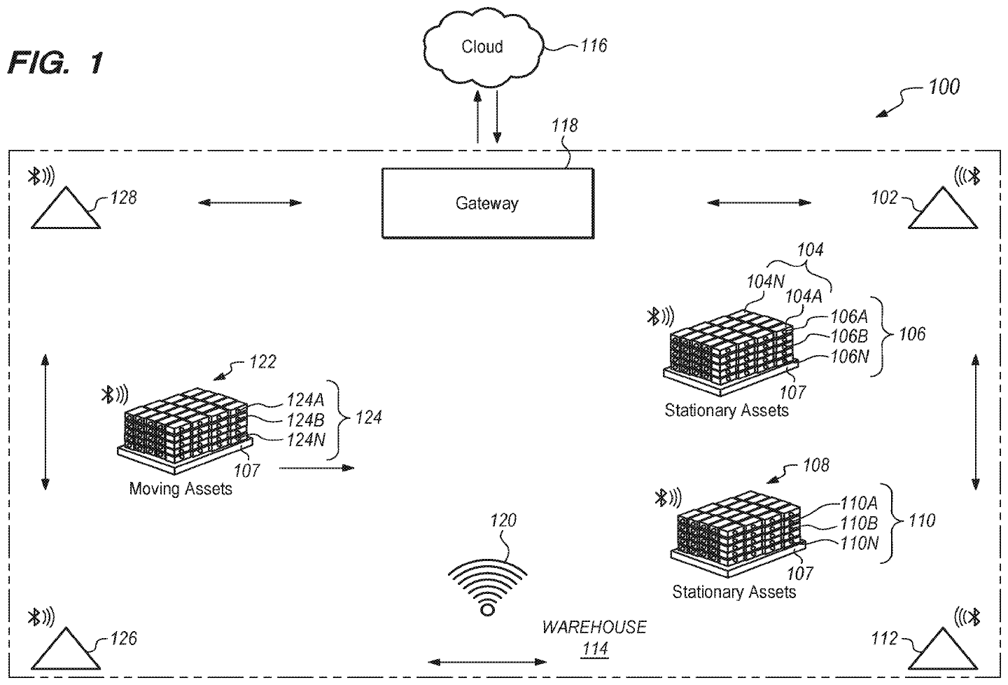

FIG. 1 illustrates an example visibility management system 100 according to the present disclosure.

In FIG. 1, visibility management system 100 includes four anchor nodes 102, 112, 126 and 128 that are communicably coupled to aggregated node groups 106, 110 and 124. Each anchor node 102, 112, 126 and 128 might be a physical element with wireless communication capabilities. Each anchor node 102, 112, 126 and 128 also has a unique ID (identification) that can be exchanged to facilitate management of aggregated node groups 106, 110 and 124. The anchor nodes may also have an external power supply to operate in a high capability state.

As shown, anchor nodes 102, 112, 126 and 128 are stationary with known coordinates. In this example, anchor nodes 102, 112, 126 and 128 are positioned around the periphery of a warehouse 114 specifically at the corners of the warehouse. This positioning facilitates determining the absolute location of aggregated node groups 106, 110, and 124 and their device nodes. The positioning also maximizes communication dispersion between the anchor nodes 102, 112, 126 and 128 and aggregated node groups 106, 110 and 124. The positioning and the number of anchor nodes can vary depending upon the warehouse layout and the particular implementation.

Although anchor nodes are referred to as being stationary, an anchor node can be mobile. For example, an anchor node may be incorporated in a robot or forklift that moves around the warehouse. Such a movable anchor node facilitates a dynamically flexible zone of operation. Further, if for instance, a weak link in the infrastructure nodes exist or an anchor node becomes damaged or has low power life, a movable robot with an on-board anchor node can replace the damage anchor node in the mesh to restore network health. Mobile groups may also be used to enact handoffs between one internal location and another.

Referring to FIG. 1, visibility management system 100 also includes aggregated node groups 106, 110 and 124, each respectively associated with assets 104, 108 and 122. By “associated with,” it is meant that each device node of aggregated node group 106, 110 and 124 is functionally or physically integrated into a corresponding asset. For example, device node 106A is physically integrated or attached to asset 104A.

Here, assets 104, 108 and 122 may be any tangible device, the location of which is to be tracked. In this example, assets may be supply chain consumables such as printer cartridges that are to be tracked. Such assets 104, 108 and 122 may be physically clustered onto pallets 107 and can be moved (e.g., via mobile connected routed movers: phone or wearable connected person, connected hand loader, robot or forklift).

The assets may be disaggregated (possibly multiple times) as part of a larger process. It is possible to find hundreds or even thousands of such assets aggregated onto multiple pallets 107, each holding 5,000 packages (for example) and each package/asset having a corresponding device node.

When hundreds to thousands to millions of device nodes are concentrated in a small volume, likelihood of channel collision increases. Many of the concentrated nodes cannot be detected due to channel collision. Such device nodes may transmit contemporaneously without synchronization so that asset visibility via such device nodes is limited and unreliable. Visibility management system 100 of the present disclosure may be employed to track movement and provenance of assets 104, 108 and 122 in a global supply chain without high channel collision.

Referring to FIG. 1, each aggregated node group 106, 110 and 124 includes multiple device nodes physically clustered in close proximity to each other. That is, each aggregated node group 106, 110 and 124 is a set of device nodes. As an example, aggregated node group 106 includes multiple device nodes 106A, 106B, . . . 106N. As another example, aggregated node group 110 includes multiple device nodes 110A, 110B, . . . 110N. And aggregated node group 124 similarly includes plural device nodes 124A, 124B . . . 124N.

Here, a device node (e.g., 106A, 110A, 124A) is a physical element with wireless communication capabilities. Thus, device nodes may communicate with the four anchor nodes 102, 112, 126 and 128. Each device node may have an on-board energy supply such as a battery as well as a unique identification that can be exchanged to facilitate device node management. The device nodes and aggregated node groups 106, 110, 124 may be moved from one location to another.

A device node has at least two operational states. In a first lower power state, the device node can allocate fewer communication resources, can be in an idle or standby state or sleep mode. In one example of this state, the device node has lower capabilities, takes no action, and may simply await an instruction signal to enter another state. A second and higher power operating state can allocate communication resources to increase frequency of RSSI (received signal strength indicator) measurements. In this state, the device node is awake to communicate with other neighboring device nodes and with the anchor nodes.

Note that device nodes may also have roles that require more or less power than the previous RSSI example, that allows a block of function of each device node to vary in the mesh for operational reasons. Within these roles, the device nodes have different power states to enable a different function.

In accordance with examples of the present disclosure, visibility management system 100 can dynamically manage these power states by causing the second higher power operating state to only occur, as in this example, when a predetermined state change condition is met. Otherwise, the device node remains in the first lower power state, and in this manner, the life span of on-board batteries of device nodes is significantly increased. In one example, an on-board battery lifespan might be increased from days or months to a few years.

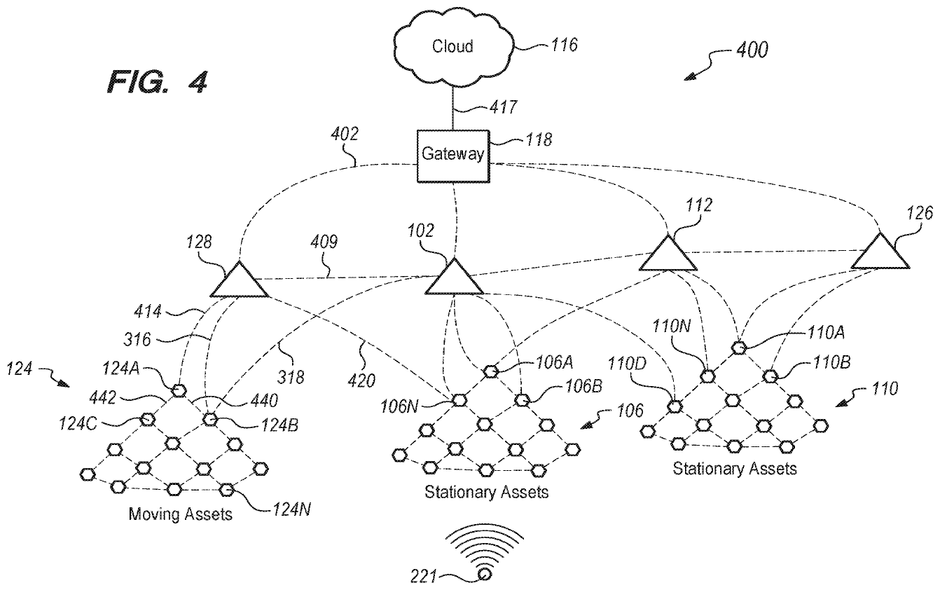

In FIG. 1, aggregated node groups 106, 110, 124 can also form a mesh network between the device nodes and anchor nodes 102, 112, 126 and 128 as further described with reference to FIG. 4. Communication between device nodes in the mesh network might be via Bluetooth LE (low energy), 802.15.4, Wi-Fi, or other wireless mesh protocols. Communication between device nodes of aggregated node groups 106, 110 and 124 and anchor nodes 102, 112, 126 and 128 can also be via Bluetooth LE. The present disclosure significantly reduces channel collision because communication signals are spatially and temporally synchronized so that systems such as Bluetooth can be selected as a design option.

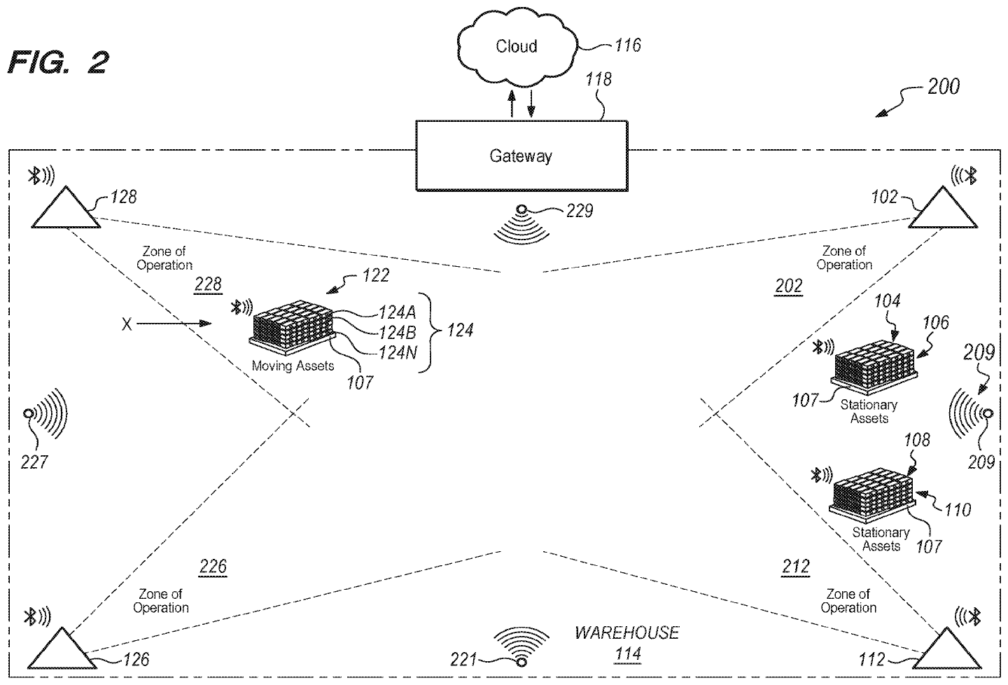

Referring now to FIG. 1, visibility management system 100 also includes reflected energy device 120 communicably coupled to gateway 118 and cloud 116. Reflected energy device 120 is a stationary communication device with a fixed location within or proximate to a zone of operation (see FIG. 2). Reflected energy device 120 can sense energy reflected from device nodes 106, 110 and 124. This information is used to aid in precisely determining the absolute position of device nodes and their associated assets. Reflected energy device 120 can power the devices up from low state with the energy that is emitted onto the targeted object. Thereafter, the reflected energy device 120 can sense the reflected energy image stream and perform signal processing to cause actions for determining position, content verification, and other available outputs/signal state changes from the reflected energy data.

In one example, reflected energy device 120 might be an optical camera. Such camera units may have an integrated light source, or the light source may be an overhead light with a source that can strobe on and off. Here, each asset (e.g., 104A) might include a mark that is detectible by reflected energy device 120. Reflected energy device 120 can also generate spatial information regarding detected items in the field of view. For example, this generation may occur with multiple reflected energy device sensors working cooperatively, via computer vision techniques for stereo image processing to gain depth information.

An example of an array with beam steering broadband radar that may be applied to obtain spatial information has the following elements: mapping location of tagged objects as a reference down to cm resolution; ability to power up items when the energy paints the objects but otherwise will not powerup the space around unpainted objects.

Use and operation of visibility management system 100 will now be described with reference to FIG. 2.

FIG. 2 illustrates an example visibility management system 200 according to the present disclosure.

Unlike FIG. 1 in which visibility management system 100 employs a single reflected energy device 120, visibility management system 200 of FIG. 2 utilizes at least four reflected energy devices 209, 221, 227 and 229. Here, the multiple reflected energy devices ensure that all surfaces of assets 104, 108 and 122 remain visible to energy signals from the reflected energy devices. Although not shown, each reflected energy device may itself be comprised of multiple reflected energy devices.

In FIG. 2, visibility management system 200 also includes a zone of operation for each of anchor nodes 102, 112, 126 and 128. A zone of operation is a volume where aggregated node groups 106, 110 and 124 are enabled to communicate with anchor nodes 102, 112, 126 and 128. In this zone of operation, assets 104, 108 and 112 can also be scanned by reflected energy devices 209, 221, 227 and 229.

In operation, visibility management system 200 is at an initial state. In this state, assets that are stationary are outside the zones of operation. Thus, as shown, assets 104 and assets 108 are stationary and are outside zone of operation 202 and zone of operation 212 respectively. Therefore, none of the reflected energy devices 209, 221, 227, and 229 receive energy reflected from assets 104 or 108.

Furthermore, in the initial state, device nodes of aggregated node groups 106, 110 and 124 are in a first or low power state. In one example, in this state, device nodes 106, 110 and 124 are not in communication with anchor nodes 102, 112, 126 and 128. In another example, in this low power state, device nodes are scheduled to switch to a higher power state to communicate with anchor nodes 102, 112, 126 and 128 at specific predetermined intervals depending upon the programmed Tx/Rx report out and wakeup nodes can occur.

When more assets such as moving assets 112 enter into the zone of operation, the assets are switched to a higher power state. Such entry might be via a forklift (not shown) that engages pallet 107 to move assets 122 to another location. As shown, pallet 107 holding assets 122 is in motion and has moved from a position X that is outside zone of operation 228 to within zone of operation 228.

Note that the local routing on the forklift may always be in a higher power state which allows it to see all the nodes in the low power state on the pallet, min mesh range communication, on the pallet as well as the nodes in the new zone. The mobile routing node on the forklift once it gets to a high enough RSSI point see all four corner nodes of the zone in its planned drop of zone point and has located its self to the position on the floor with its digital map it was assigned via AOD/AOA it puts the pallet down on the floor and moves away. Once completed, this process switches the mobile routing node (example forklift) into a low power state, so the nodes are ready to connect to the nodes 102, 112, 126 and 129. Once beam steering onto the pallet has occurred, the nodes begin to wakeup post beam steering onto that pallet has allowed authentication and wakeup, and create a master group of nodes to take over the shared roles that were once held by the one master mobile node on the forklift and these nodes then wake up to a higher power state for the remaining nodes within the pallet into the optimized matrix in the cube for power/link budget/roles/environment/timing.

Upon assets 122 moving into zone of operation 228, at least one of reflected energy devices 209, 221, 227 or 229 transmits energy to aggregated node group 124 containing assets 122. The energy is then reflected back to reflected energy devices 209, 221, 227 or 229 to detect motion of assets 122 and or to begin a series of operations to analyze and validate for the chain of custody the box's, their content, any theft logs, any other learned history, while overlaying the WSN AOA/AOA positioning data to the visualization data acquired by the REDs. Each reflected energy device 209, 221, 227 and 229 has spatial and temporal discrimination so that motion can be detected adding in a securely transmitted signal that can be interpreted as an image or stream vs a known library or model by analyzing its output.

Specifically, in one example, the energy is transmitted by reflected energy device 221. This transmitted energy is then reflected from aggregated node group 124 and/or assets 122. The reflected energy is received by reflected energy device 221 to detect the movement/motion (for example) of aggregated node group 124 and assets 122.

In this example, when motion (for example) of aggregated node group 124/assets 122 is detected within zone of operation 228, the anchor node closest to zone of operation 228 is identified. Here, anchor node 128 is identified as the closest anchor node. In one example, visibility management system 200 then utilizes anchor node 128 to relay state change instruction signals to change the operating states of device nodes of aggregated node group 124. In another example, it is reflected energy device 221 that is used to transmit state change instruction signals to change the operating states of device nodes of aggregated node group 124. In this example, the reflected energy device 221 may send power and signal to cause interruption to the state change circuitry of a device node. In this manner, in-band radio traffic is not increased.

Here, a first change state instruction signal can direct the device nodes of aggregated node group 124 to change from a low (or lower) power to state to a high (or higher) power state. In this higher power state, more frequent RSSI measurement may occur, and device identification and location information may be exchanged and communicated to anchor node 128 for storage or processing by computing resources at gateway 118.

In this high-power state, device nodes of aggregated node group 124 are awake and begin more frequent communication with anchor node 128 (or an appropriate reflected energy device) including exchanging ID information with anchor node 128. The communication with anchor node 128 can be direct or via the mesh network. In turn, anchor node 128 measures the RSSI from each device node and between each device node. Anchor node 128 then forwards all of the information to gateway 118.

Gateway 118 uses RSSI information and the known location of anchor node 128 (and other anchor nodes) to determine the location of aggregate node group 124 and all device nodes within the aggregate node group. The position of aggregate node group 124 may be determined based on its distance from known anchor nodes, each of which is used as a reference. Examples of techniques that can be used include RSSI, AOA, AOD, TOF. Thus, gateway 118 can determine how many corresponding assets there should be and whether an asset is missing.

Thus, the state change instruction signals cause communication resources to operate at a different power performance point. Communication resources can direct when and how device nodes are assigned to communicate wirelessly. A resource may include channel (frequency), future time windows—when communication is allowed and expected and/or radio power level which affects transmitted signal strength.

In FIG. 2, gateway 118 and/or external computer elements can implement holistic policies for visibility management system 200 performance. For example, an application may require device nodes 124A, 124B and 124C to respond to a command to move to high power and frequent mesh network communications to be propagated to all aggregated node group 124 devices within n seconds.

With such centrally administered control, the present disclosure facilitates interrogation of the system's mesh network topology to determine the state-change-command latency (typical and worst case) for each device node under a given set of node power-performance operating points.

This change in power state may be temporary. After either a time-out or upon detection that movement of aggregated node group 124/assets has ceased, instructions to enter the low or lower power state are sent to the device nodes via a reflected energy device, an anchor node 128 or a communication device. Note that as used here, the communication device may itself be the reflected energy device or an anchor node or separate communication device that is part of the network and is in communication with the device nodes.

Specifically, upon detecting the state change event such as cessation of movement or upon a timeout, the appropriate device (anchor node 128, a reflected energy device or another communication device) may communicate a second change state instruction signal that directs the device nodes to enter a low (or lower) power state. In this manner, communication assets in play are adjusted dynamically allowing power to be used efficiently. Note that the device nodes can be given a program ability to execute a delayed state change command. Thus, after a commanded time interval, a device node can enter a different power state.

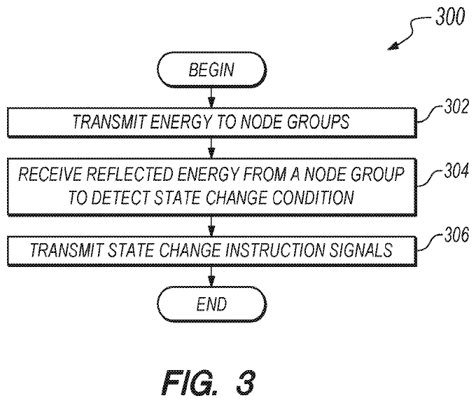

FIG. 3 illustrates method 300 for dynamically managing device node power states according to an example of the present disclosure.

In FIG. 3, at block 302, method 300 begins by transmitting energy to aggregated node group 124 (FIG. 2). Here, the energy may be transmitted by reflected energy device 221 (FIG. 2). Moreover, as previously noted, aggregated node group 124, which includes multiple device nodes 124A, 124B, . . . 124N, (FIG. 1), may be in motion. In this example, aggregated node group 124 and associated assets 122 are located on pallet 107 (FIG. 2). So, pallet 107 is moved by a forklift (not shown) from one location of warehouse 114 (FIG. 2) to another location.

At block 304, reflected energy from aggregated node group 124 and/or associated assets 122 is received by reflected energy device 221 to detect a state change event associated with aggregated node group 124. An example of a state change event is physical motion as in this case the movement of aggregated node group 124.

Another example of a state change event is the removal of an asset and corresponding device node (e.g., asset 122A/device node 124A) from assets 122. Yet, another example of a state change event is loss of communication from a device node when an associated asset becomes damaged.

In one example, upon detection of a state change event, a log or report that includes the state change event may be generated. The log may be generated and stored on an on aggregating routing node, anchor node or gateway anchor node. Alternatively, the log may be generated and transmitted via a gateway to a remote monitoring location. In this manner, monitoring of movement and detection of movement anomalies can be tracked. Moreover, by way of reporting out state change events, an external control system can manage lost (or unexpectedly added) assets from an aggregation. An example state change report might be as follows.

| | | ID of | | |
|---|---|---|---|---|
| | | Aggregated | Device | Anchor |
| Event Date | Type of Event | Node | Node ID | Node ID |
| Jan. 1, 2018 | Movement of | 091444 | 0001- | 2190 |
| | Aggregated | | 5000 | |
| | Group | | | |
| Feb. 4, 2018 | Node Removal | 091143 | 10,000- | 2171 |
| | | | 15,000 | |

Although two event types are shown in the table above, the report may include additional or fewer events. The report may also include additional or fewer details for each event.

Here, the reflected energy sensed by reflected energy device 221 is used to aid in precisely determining the absolute position of aggregated node group 124 and associated assets. Reflected energy device 221 may include sensor devices such as an optical camera that uses computer vision techniques to generate spatial data, detect movement and to track aggregated node group 124.

In this example, assets of aggregated node group 124 may include patterned marks that are detectable by the optical camera. In one example, the motion of aggregated node group 124 can be detected by measuring change in speed or vector of aggregated node group 124. Any number of background subtraction techniques including adaptive median filtering, Running Gaussian Average, Gaussian Mixture Models or Prati Mediod may be applied to detect such motion, and to locate and track aggregated node group 124.

In another example, reflected energy device 221 might include a broadband radar sensor array, and an irradiating energy source may be a phased array of radar emitters with spatially controlled frequencies and phases. The phased array might be steered toward a corresponding zone of operation. The number of transmit and receive antenna elements and the frequency and phase of each antenna element might vary based on the size and layout of the warehouse involved. Note that image or streams of images received by the phased array may be used to securely map and control vs edge libraries.

In another example, reflected energy device 221 might incorporate an ultrasound transceiver that can emit and detect ultrasonic energy to detect and locate aggregated node group 124. A combination of different energy sensor types may be used in tandem where collectively, the reflected energy device's sensors collect sufficient information to locate and identify individual nodes in 3D spatial coordinates.

Thus, the present disclosure does not require the detection of state changes through devices that are within assets or device nodes. That is, the present assets/device nodes need not incorporate accelerometers, gyrometers or the like. Any such requirement would be a challenge because the device nodes would involve intelligence, which not only increases the cost of each asset unit but also reduces the lifespan of any on-board power supply. The present disclosure uses systems external to the device nodes and assets. In one example, the present systems can utilize existing building infrastructure. In dynamically managing power states of aggregated node groups, the present disclosure significantly reduces unit costs because device nodes and assets do not incorporate sensors translating to a reduction in asset costs.

At block 306, anchor node 128 relays a state change instruction signal to aggregated node group 124. In this example, when motion of aggregated node group 124/assets 122 is detected within zone of operation 228, anchor node 128—the anchor node closest to zone of operation 228— is used to relay the state change instruction signals. Note that the state change instruction signals need not be relayed by the anchor node. The state change instruction signals may instead be transmitted by reflected energy device 221 or another network communication device.

The state change instruction signals direct device nodes of aggregated node group 128 to change their operating states and enter a different power level. This state change instructional signal is propagated via a mesh network to the desired set or number of device nodes in aggregated node group 124.

A first change state instruction signal can direct the device nodes of aggregated node group 124 to change from a low (or lower) power state to a high (or higher) power state. In this higher power state, more frequent RSSI measurement may occur, and device identification and location information may be exchanged and communicated to anchor node 128 for storage or processing by computing resources at gateway 118.

After either a time-out or upon detection that movement by aggregated node group 124/assets 122 has ceased or upon detection of cessation of any other change state, anchor node 128 sends a change state instruction signal to aggregated node group 124 to enter a low or lower power state. This change state instruction signal is again propagated to the desired device nodes in aggregated node group 124.

In this manner, examples of the present disclosure can dynamically manage device node power states such that device nodes remain in a lower power state that consume little or no energy until a state change condition occurs. The system can therefore remain active and functional for many years without a loss in communication due to device node power supply failure.

FIG. 4 illustrates an example mesh topology 400 of visibility management system 100 of FIG. 1.

In FIG. 4, mesh topology 400 includes gateway 118 and cloud 116 that are communicably coupled via a backbone 417. Gateway 118 and anchor nodes 128, 102, 112 and 126 are also communicably connected via a link 402. Thus, gateway 118 can communicate instructions to anchor nodes 128, 102, 112 and 126 to change the power states of relevant nodes, for example.

Not only are the anchor nodes communicably connected to gateway 118 and to each other (as permitted by transmission power/distance), the anchor nodes may also communicate with aggregated node groups within their zone or zones of operation. Thus, anchor nodes 128, 102, 112 and 126 may communicate with each other via link 409 or via gateway 118. Anchor node 128 may then communicate with aggregated node group 124 (e.g., device node 124A via link 414) and may further talk to another aggregated node group 106 (e.g., device node 106N via link 420).

This mesh topology allows communication between device nodes of an aggregated node group. For example, in aggregated node group 124, device node 124A and device node 124C can communicate via link 442. Device node 124A can also talk to device node 124B via link 440.

Device node 124B may communicate with device node 124N via any one of several multi-path links. This same inter-node connectivity is shared by device nodes in other aggregated node groups 106, 110 as shown in FIG. 4. In one example, communication between the device nodes is via Bluetooth LE, 802.15.4, Wifi; communication between device nodes and anchor nodes is also via Bluetooth LE.

Mesh network topology 400 thus provides inter-device communication to establish to optimum routing of messages. Each communication is spatially and temporarily synchronized to avoid channel collision. Each communication is also securely transmitted via authorization via images/streams of images vs edge libraries. This implementation is particularly beneficial where large nodes are physically aggregated as in the present example. In one example, about 5,000 device nodes and their associated assets are aggregated onto a pallet. The multi-path connections between the nodes also provides redundancy.

As previously noted, each device node has at least two power states: a low-power state and a high-power state. When motion is detected as previously described, gateway 118 directs anchor node 128 to send an instruction signal to aggregated node group 124. The instruction signal might direct at least one node to enter a higher or lower power state.

In the example of FIG. 4, the instruction signal may be received by device node 124A. In turn, device node 124A communicates that instruction to device node 124B. The instruction is then propagated with spatial and temporal synchronization to the entirety (if desired) until the last device node 124N is instructed. It is noted that the instruction can be different power state commands to different nodes in the aggregation. The device nodes don't have to all be directed to the same thing together. Mesh topology 400 also uses RSSI and phase as a crude measure of inter-node proximity. Examples of other techniques that might be used include AOA, AOD, TOF or other painted direct mapping techniques.

In one example of the present disclosure, location is determined locally and no more than classifications results are sent to the cloud; data is not sent. Optionally, a log of state change events can be transmitted. For example, the log may indicate asset separation. The present disclosure is flexible and combines RSSI data with reflected energy device data to better manage assets' energy and to better track assets. Device nodes of the present disclosure can have multiple operating states trading off power and performance. The device nodes can be homogeneous or heterogenous.

Alternative Control Vector for Wakeup: The example above uses the mesh topology network 400 to propagate device node control commands that change the power-performance operating points of any (or all) device nodes in the mesh. A wakeup circuit may be employed to force a low state device node into an immediate communication state change in response to a detected external signal. This wakeup circuit can facilitate response to state change commands within a short time frame. In one example, a wakeup circuit might receive a signal from a broadcast component that uses a single channel (frequency) and the broadcast message is received by all device nodes. The message may contain a list of device node IDs as well as new operating points for each transmitted ID. The wakeup may be controlled by reflected energy device signals and or routed interrupt signals from a gateway.

Other wakeup type circuits are possible. For example, a wakeup circuit can address device nodes by targeting each device node wakeup circuit individually. The nodes may be hit with a broadband RED spectrum and kept in a state with comparator to then have burst sent to them uniquely with commands for that node. If a node is not unlocked, then that node in incapable of receiving the change commands. The system may send in the broadband signals one or an aggregate of frequencies, at a certain power level to enable the threshold to be met.

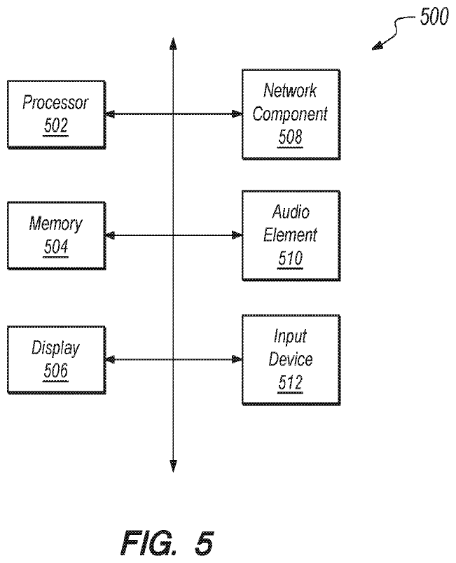

FIG. 5 illustrates a computer system architecture suitable for implementing examples or components to manage power states of aggregated node groups of the present disclosure. System 500 may facilitate the visibility of assets associated with the aggregated node groups. System 500 may implement a gateway or an anchor node that instructs device nodes of the aggregated node group to enter a different power state.

When system 500 is implemented within an anchor node, for example, and motion of an aggregated node group is detected within a zone of operation, system 500 executes, under control of processor 502, machine executable software instructions stored in memory 504 to communicate or relay state change instruction signals to change the operating states of device nodes of aggregated node group. Here, memory device 504 might include various memory types, data storage, or non-transitory computer-readable storage media. A user may utilize input device 512 to execute a browser or other machine executable software instructions to facilitate communication of state change conditions according to the present disclosure.

A first change state instruction signal can direct the device nodes of aggregated node group to change from a first power to state to a second power state. In a higher power state, machine executable software instructions stored in memory 504 may be executed to exchange device identification and location information with computing resources at the gateway. The anchor node may be communicably coupled the gateway via network component 508. Display element 506 such as a touch screen interface may visually display logs of state change conditions that are encountered, and the logs may also be communicated to the gateway via network component 508. An audio alert of a state change condition may be delivered via audio element 510 such as speaker.

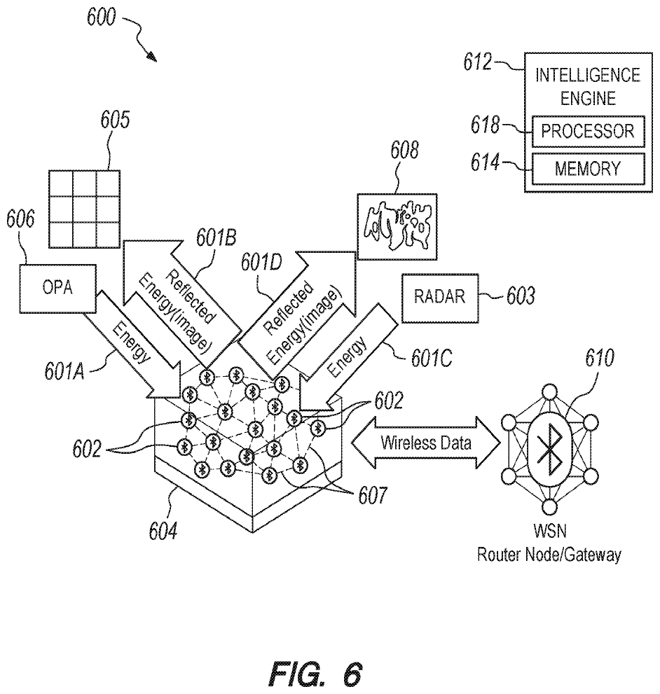

FIG. 6 illustrates a system 600 for relaying energy between device nodes 602 of an aggregated node group 604 according to an example of the present disclosure. Specifically, energy may be relayed from one device node 602 to a neighboring device node 602 of aggregated node group 604. This aggregated node group 604 is shown in FIG. 6 within a pallet of product supplies.

As previously discussed, (see FIG. 1), an aggregated node group such as aggregated node group 604 may include multiple device nodes 602 physically clustered in close proximity to each other. In some instances, hundreds or even thousands of assets with device nodes 602 may be aggregated onto multiple pallets, each holding 5,000 packages (for example) and each package/asset having multiple corresponding device nodes 602.

As shown in FIG. 6, energy waves 601A and 601C may be transmitted to aggregated node group 604 to actuate and toggle device nodes 602 that are in a low power state into a higher power state. Here, and as previously discussed with reference to FIG. 2, the type of REDs (reflected energy devices) for transmitting energy waves 601A and 601C may vary.

In one example, the RED may be a heterodyne OPA (optical phased array) 606. The heterodyne OPA 606 computationally replaces lens functionality and manipulates incoming light to capture an image. The heterodyne OPA 606 has a large array of light receivers (not shown), each of which can individually add a tightly controlled time delay (or phase shift) to the light it receives, thereby enabling the image capture device to selectively look in different directions and focus on different things.

The energy waves 601A and 601C transmitted by the heterodyne OPA 606 may be reflected by the aggregated node group 604 as energy streams (image) 601B. The reflected energy stream 601B may be an OPA image 605 comprised of black and white image patterns of aggregate node group 604 as shown. Thus, this reflected energy stream 601 is to provide an indication of the state of the device node network as to which device nodes 602 are in a low power state and which ones are awake.

In another example, the RED may be a phased array of radar emitters (or RF, ultrasound, etc.) 603 with spatially controlled phase and frequencies. In yet another example, the RED may be based on scalar magnetic waves.

In the case of the RED being a phased array of radar emitters, as shown, the energy waves transmitted by the RED—radar emitters 603 may be reflected by aggregated node group 604 as reflected energy streams 601D. Any suitable portion of the electromagnetic spectrum, ultrasound, etc. may be used for the energy waves 601A, 601B, 601C, and 601D, and the RED may be an array designed to operate in the desired portion of the electromagnetic, sound or other directable energy form (e.g., RF/microwave, Terahertz, infrared, visible light, ultra violet, x-ray, etc.).

The reflected energy stream 601D may be doppler image streams 608 of aggregate node group 604 as shown. In other words, a stream of images of aggregated group node 604 can be obtained. In one example, the reflected energy streams 601B and 601D provide a complete 3D image of the aggregate node group 604. The volume of 3D image data streams may be based on single or multiple REDs. It is noted that an aspect of the present disclosure is that image data streams of device nodes 602 may be matched to library referenced recorded streams to authenticate the validity of the device nodes, as well to give alerts, such as for security violations.

The REDs 603 and 606 may also transmit power to device nodes 602 to wake up the device nodes 602. Specifically, the REDs 603 and 606 may beam steer an energy beam to a cross section of space, with some post object contact resulting in a volumetric diffraction/reflection/absorption effect, still permitting actuation and a wakeup state for device 602. When the energy beam is at that cross section in space, device nodes 602 wake up, and when the energy beam moves from that point, device nodes 602 enter into the low power state. Thus, the REDs 603 and 606 are controlling in time and space, the operations, roles, actions and states within device node 602, and they cause the actuation of device nodes 602. Here, unlike many systems where actuation is controlled from the inside of the device node (e.g., via an accelerometer), in the present disclosure, actuation by the REDs is external to the aggregated node group 604.

Specifically, as shown in FIG. 6, system 600 may include an intelligence engine 612 to cause the REDs 603 and 606 to spatially control the actuation/deactivation of device nodes 602. The intelligence engine 612 may also include memory 614 and a processor 618.

When the reflected energy streams, which may be images 605 and 608 are received, intelligence engine 612 becomes aware of which device nodes 602 can be reached because such device nodes 602 are visible in images 605 and 608. Moreover, the reachable device nodes 602 may also transmit a signal through the mesh wireless protocol network 607 and the WSN (wireless sensor network) Router Node/Gateway 610 to the intelligence engine 612.

As shown in FIG. 6, all of the device nodes 602 may form a mesh wireless protocol network 607 allowing device nodes 602 to communicate with each other and with the intelligence engine 612 via WSN (wireless sensor network) Router Node/Gateway 610. Thus, the intelligence engine 612 can realize which portion of the entire network is awake. The intelligence engine 612 can then determine all of the device nodes 602 that are in a low power state and that need to be toggled to a higher power state.

In essence, it is determined whether a device node 602 can be seen, and if so, whether the device node 602 can also be heard. If a device node 602 cannot be seen or heard, then the entirety of the network is not fully established. Here, a two-factor analysis is utilized for determining when a device node 602 is actuated: 1) whether the relevant device node 602 is visible within the reflected energy image system; and if so, 2) whether the device node 602 is transmitting a signal via the mesh wireless network protocol 607. If so, the intelligence system 612 assigns an active state to the device node 602.

As shown in FIG. 6, energy waves 601A and 601C are being delivered to aggregated node group 604. As the energy waves 601A and 601C wane, the arrows 601A and 601C change gradually from a dark color to a lighter shade. The energy waves 601A and 601C then eventually become lost. The energy waves 601A and 601C are thus unable to penetrate deep into the pallet to actuate the device nodes 602 that are deep into the pallet.

In other words, embedded device nodes 602 that are in heavily dampened or shielded zones, such as the center of a pallet of liquid goods, are unable receive direct energy from REDs 603 and 606. Thus, any such device nodes may remain in a perpetual low power state and only provide minimal visibility services on and through this node to the entire mesh network. As a consequence, a fail state is recorded by the RED system 3D map for location and visibility. Until a relayed power state sequence initiation shows all states are possible in diagnostic mode to the mesh, the device node is not allowed to authenticate into the mesh. Without this visibility of operational capabilities being toggleable, the system would be considerably impacted for effectiveness and reliability of any associated asset visibility system.

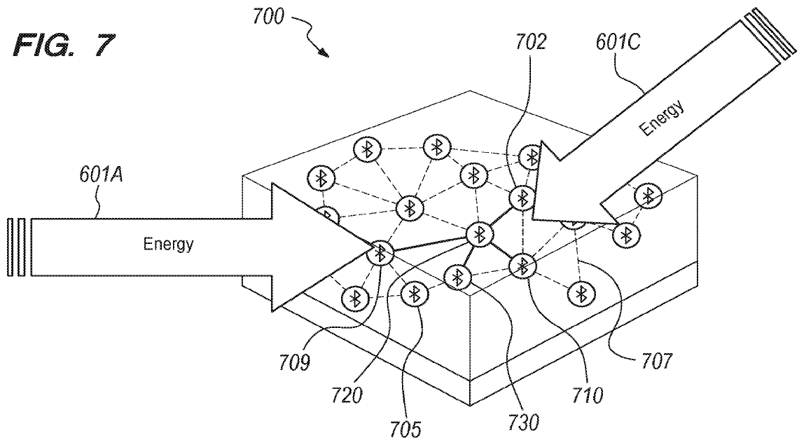

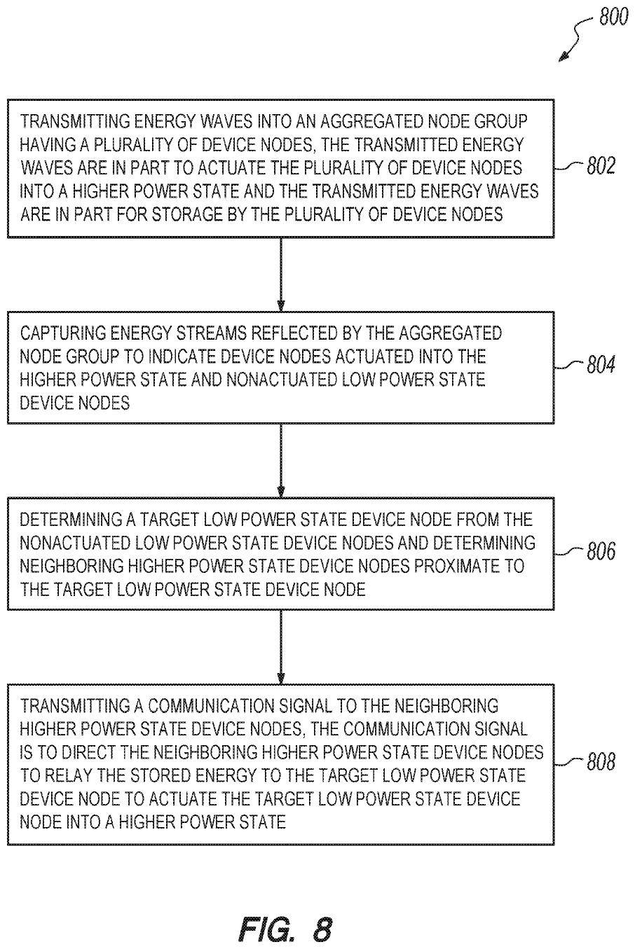

The present disclosure can power up such non-actuated device nodes 602 to considerably increase the effectiveness and reliability of asset-visibility systems as further described with reference to FIGS. 7 and 8 below.

FIG. 7 illustrates an aggregate node group 700 having a non-actuated inner node 720 that can be actuated to a higher power state according to an example of the present disclosure. In FIG. 7, energy waves 601A and 601C (from the REDs 603 and 606 of FIG. 6) are unable to penetrate deep into the pallet to reach and actuate inner node 720.

However, the neighboring nodes 702, 710, 730, 705, 709 can be reached by energy waves 601A and 601C from the REDs 603 and 606. Therefore, the neighboring nodes 702, 710, 730, 705, 709 are actuated, and they transition into a higher power state. As for the inner node 720, it remains in a low power state.

The intelligence engine 612 can determine that the inner node is in a low power state based on the two-factor analysis mentioned above: 1) based on the RED image system; and 2) on the mesh wireless protocol network 607. Here, the RED image system would show a 3D image of aggregate node group 700 without inner node 720 being visible.

Further, no signal from inner node 720 would be received via the mesh wireless network protocol 607. Specifically, all of the device nodes 702, 710, 730, 705, 709, 720 707 form a mesh wireless protocol network and can communicate with each other and with the intelligence engine 612 of FIG. 6. Therefore, when no RED response signal is received from the inner node 720, the intelligence engine 612 concludes that inner node 720 needs to be actuated into a higher power state.

The intelligence engine 612 then directs neighboring nodes 702, 710, 730, 705, 709 and 707 to relay energy to inner node 720 as shown. Inner node 720 therefore becomes activated and transitions to a higher power state. In one example, the energy that is relayed to inner node 720 is supplemental energy stored by the REDs on on-board storage devices. In one example, the storage device may be a battery. In another example, the storage device may be a capacitor. Other comparable storage device types may be employed.

In another example, the energy relayed to the inner node 720 from neighboring nodes 702, 710, 730, 705, 709 is a fixed amount of energy specified by the intelligence engine 612. In another example, energy may be relayed until a predetermined amount of energy remains or a minimum power level is reached. The neighboring nodes 702, 710, 730, 705, 709 attempt to transmit the maximum capacity to inner node 720 to meet the actuation threshold and communicates back and authenticates its state/role change. Otherwise, the neighboring device nodes 702, 710, 730, 705, 709 exhaust attempts and hit the minimum power level allowed for the outer nodes and stop relaying. Inner node 720 may then be toggled to a higher state and can be both seen and heard. At this point, all of the neighboring nodes 702, 710, 730, 705, 709 can have their energy replenished. Consequently, the intelligence engine 612 directs the REDs to replenish the power of the neighboring nodes 702, 710, 730, 705, 709

In this manner, no device node remains in a perpetual low power state, and device failure and asset losses associated with failed devices can be avoided. Consequently, the effectiveness and reliability of any associated asset visibility system is greatly increased.

It is noted that all device nodes 702, 710, 730, 705, 709, 707 and 720 have at least a dual antenna (transceiver or transducer) to adjust the phase and to shape the direction and lobes of the energy that the device nodes relay. Although a dual antenna is illustrated herein, other comparable transmit/receive systems may be utilized. For example, CMUT (capacitive micromachined ultrasonic transducer) may be used. As another example, a laser/led system may be employed. The phase and shape adjustment may be by using lower power states to initiate a gradient decent technique coming from the RED device to maximize signal strength and energy delivery of the array to the neighboring nodes to map out the optimized configurations, energy from each neighboring node can thereafter be directed at a higher level specifically at the inner node 720. In this manner, energy from each neighboring node can be directed specifically at inner node 720 to minimize environmental, destructive interference, and alignment, for in band and out of band energy delivery.

The communication may be out of band from the energy transfer. As an example, the energy transfer from the RED 603 may be a section of an array with multiple beams steered at 20 GHz directed at an aggregated node group to toggle device nodes in the aggregated node group, while communication between device nodes and the intelligence engine/REDs may be via 2.4 GHz radio link, for example. As another example, the RED 603 may be a broadband source of 100 mhz to 140 ghz for RF directed at the aggregated node group. Each node is tuned to filter one or more bands at a certain threshold level to turn on the device. An example is a multi-notch or single notch filter. It is noted that because device nodes know their neighbors/friends and may tune the phase/direction/lobes in advance in some examples, they can quickly respond to a command from the intelligence engine 612 to transfer power.

Furthermore, the intelligence engine 612 may go through a learning procedure, sweeping an optimized matrix of power and phase for aggregated TX nodes and receiving RX node, relative to known external conditions (known noise, physical imaging of adjacent pallets, types of classified contents in this pallet and adjacent pallets, etc.). In an example, the goal is to optimize and turn on zones so there is no “blinking”— unstable time in the mesh protocol network. It also tunes in a communications/power function. The intelligence engine 612 may include a procedure for ad hoc mesh building to initially optimize the system with the lowest power capability for the link budget relative to some overhead in the link budget to maintain a reliable mesh when the aggregate node group(s) on a pallet are first built. The intelligence engine 612 is used to optimize this over time for the aggregate node group on the pallet and in different environments.

Specifically, the intelligence engine 612 has an adhoc mesh building process to initiate and optimize a mesh based on the previously discussed criteria that are more than RSSI. There is a look ahead function of the RED based on the library files at setup. Additional learning outside of setup builds models to optimize for repeated actions in the environment.

After reaching a higher power state for the first time, all of the device nodes can rely on the device node battery or other storage devices to maintain a higher power state. In other words, during initial coverage of the device nodes by the REDs, sufficient power is conveyed to last the lifetime of the device nodes. However, if a device node has a storage problem, the device node and neighboring nodes may notify the intelligence engine 612 so that an additional set of relay nodes can be used to recharge the power-deficient node. Likewise, with a matrix of state, function, power, needs (sensor trigger sent to the intelligence engine per node), the intelligence engine 612 can use the data fusion of the wireless location data with the RED data to optimize the choices for additional relay nodes to be used for recharging power-deficient nodes.

FIG. 8 illustrates a method 800 of relaying energy (e.g., energy waves 601A and 601C of FIG. 7, energized by examples REDS 603 and 606 in FIG. 6) to an example device node (e.g., inner node 720 of FIG. 7) according to an example of the present disclosure.

At block 802, method 800 includes transmitting by REDS 603 and 606 energy waves 601A, 601C into an aggregated node group 700 having a plurality of device nodes 702, 710, 730, 705, 709, 704 and 720 wherein the transmitted energy waves are to actuate the plurality of device nodes 702, 710, 730, 705, 707, 709 into a higher power state and are in part for storage by the plurality of device nodes 702, 710, 730, 705, 707 and 709.

At block 804, method 800 involves capturing by REDS 603 and 606 energy streams 601B and 601D (e.g., of FIG. 6) reflected by aggregated node group 700 to indicate the plurality of device nodes 702, 710, 730, 705, 707, 709 actuated into the higher power state and non-actuated low power state device node(s) 720.

At block 806, method 800 is to determine by REDS 603 and 606 and/or intelligence engine 612 a target low power state device node 720 from the non-actuated low power state device node(s) 720 and to determine neighboring higher power state device nodes 702, 710, 730, 705, 709 proximate to the target low power state device node 720.

In one example, determining the target low power state device node is by determining whether the non-actuated low power state device 720 is visible in a 3D image volume of the aggregated node group 700. In addition to visibility in the 3D image volume, the determination of the target low power state device node 720 may be by determining whether a signal is received from the non-actuated low power state device node 720 via the mesh wireless protocol network 607 (FIG. 6). In some examples, determining the neighboring higher power state device nodes 702, 710, 730, 705, 709 is by determining which device nodes 702, 710, 730, 705, 709, 707 were friend (adjacent) device nodes of the target low power state device node 720 when the mesh wireless protocol network 607 was established.

At block 808, method 800 is to transmit a communication signal to the neighboring higher power state device nodes wherein the communication signal is to direct the neighboring higher power state device nodes 702, 710, 730, 705, 709 to relay the stored energy to the target low power state device node 720 to actuate the target low power state device node 720 into a higher power state. The communication signal may be caused by the intelligence engine 612 which is communicably coupled to REDs 603 and 606 and the plurality of the neighboring higher power state device nodes 702, 710, 730, 705 709.

The method 800 of the present disclosure can optimize device node power states of an aggregate node network not only by increasing device node power states but also by toggling higher power states to lower power states.

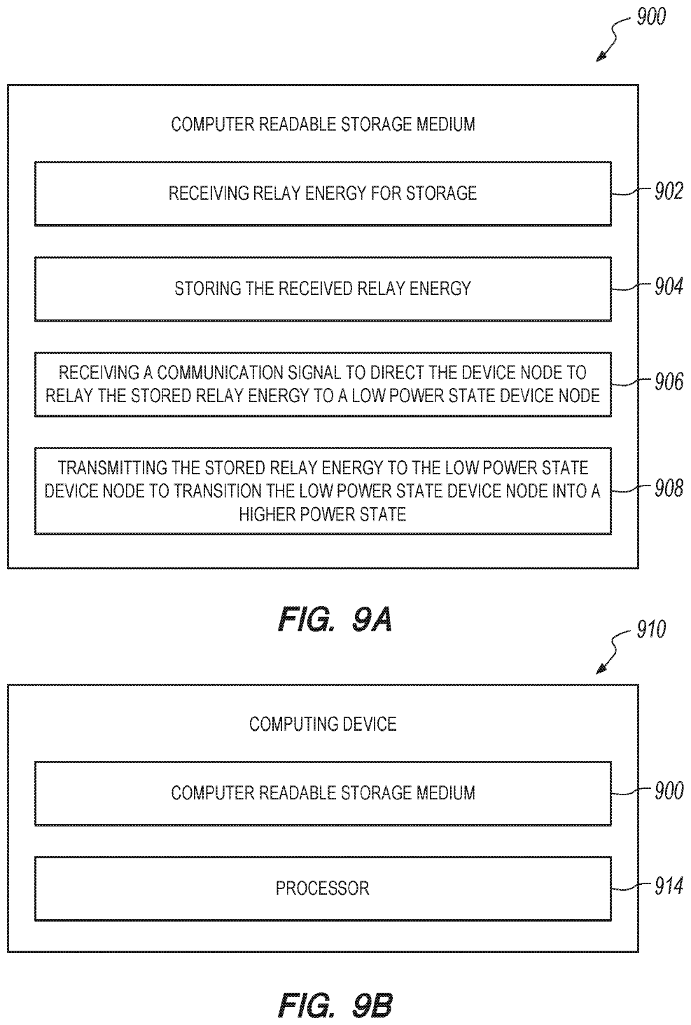

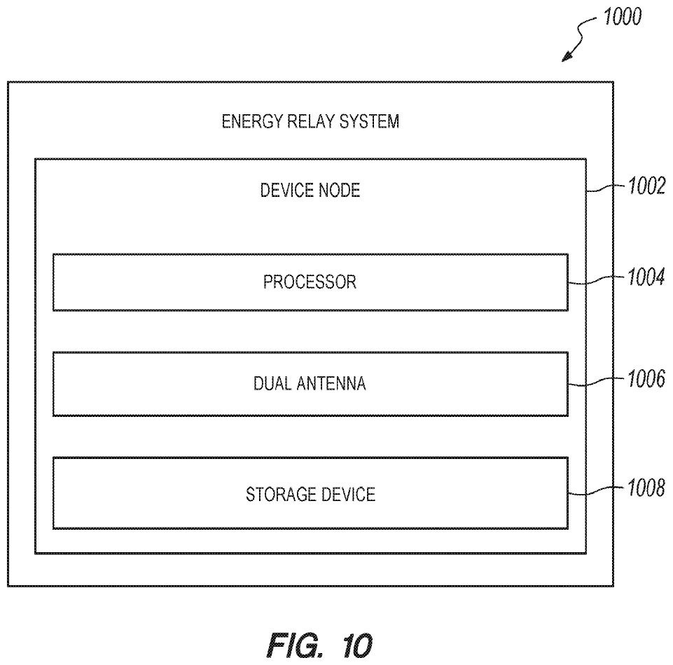

FIG. 9A illustrates example instructions stored on a non-transitory computer-readable storage medium 900 to relay energy to device nodes according to the present disclosure. FIG. 9B illustrates an example computing device 910 according to the present disclosure.

In FIG. 9A, the non-transitory computer readable storage medium 900 may include instruction 902 and instruction 904. Here, instruction 902 may cause a processor 914 of FIG. 9B to cause a device node (e.g., neighboring device node 730 of FIG. 7) to receive relay energy for storage. The relay energy may be received by a neighboring device node such as neighboring device node 730 of FIG. 7. As used herein, “relay energy” is energy received by a device node for temporary storage and that is intended for transmission to a neighboring device node.

In FIG. 9A, instruction 904 may cause the processor 914 to cause the device the device node to store the received relay energy. As noted above, an example of a device for storing the relay energy may be an on-board capacitor. Another example of a storage device may be a battery.

The non-transitory computer-readable storage medium 900 may further include instruction 906 and instruction 908. Instruction 906 may cause the processor 914 to cause the device node to receive a communication signal and direct the device node (to relay the stored relay energy to a low power state device node. An example of the low power state device node may be inner device node 720 of FIG. 7. Instruction 908 may cause the processor 914 to cause the device node to transmit the stored relay energy to the low power state device node (e.g., inner device node 720) to transition the low power state device node into a higher power state.

FIG. 10 illustrates an energy relay system 1000 for relaying energy to other device nodes according to an example of the present disclosure. The energy relay system 1000 may include a device node 1002. The device node 1002 may itself include a processor 1004, at least dual antennas 1006 (Tx and Rx) to receive and transmit energy and a storage device 1008 to store the energy received via the dual antennas 1006.

Here, the device node 1002 may receive a communication signal directing the device node 1002 to relay the stored energy to a target low power state device node to actuate the target low power state device node into a higher power state. The processor 1004 may cause the dual antennas 1006 to transmit the stored energy to the target low power state device node.

In one example, the energy received by the device node 1002 may be from a reflected energy device such as RED 603 or 606 of FIG. 6. For some examples, the node device 1002 is within an aggregated node group that reflects the energy to indicate device nodes that are actuated into a higher power state and non-actuated low power state device nodes. In an example, the energy relay system 1000 may include an intelligence engine (e.g., intelligence engine 612 of FIG. 2) to cause transmission of the communication signal.

While the above is a complete description of specific examples of the disclosure, additional examples are also possible. Thus, the above description should not be taken as limiting the scope of the disclosure, which is defined by the appended claims along with their full scope of equivalents.

1. A method of relaying energy to device nodes, the method comprising:
transmitting energy waves into an aggregated node group having a plurality of device nodes, wherein the transmitted energy waves are to actuate the plurality of device nodes into a higher power state and are in part for storage by the plurality of device nodes;
capturing energy streams reflected by the aggregated node group to indicate the plurality of device nodes actuated into the higher power state and non-actuated low power state device nodes;
determining a target low power state device node from the non-actuated low power state device nodes and determining neighboring higher power state device nodes proximate to the target low power state device node; and
transmitting a communication signal to the neighboring higher power state device nodes, wherein the communication signal is to direct the neighboring higher power state device nodes to relay the stored energy to the target low power state device node to actuate the target low power state device node into a higher power state.

2. The method of claim 1 wherein the energy transmission is by a reflected energy device.

3. The method of claim 1 wherein the reflected energy streams are a volume depicting a 3D image of the aggregated node group with the device nodes actuated into the higher power state and the non-actuated low power state device nodes.

4. The method of claim 1 wherein the communication signal is caused by an intelligence engine communicably coupled to the reflected energy device and the plurality of device nodes.

5. The method of claim 3 wherein determining a target low power state device node is by determining whether the non-actuated low power state device is visible in the 3D image volume.

6. The method of claim 5 wherein determining a target low power state device node is by determining whether a signal is received from the non-actuated low power state device via a wireless mesh network.

7. The method of claim 1 wherein determining neighboring higher power state device nodes is by determining which device nodes were friend device nodes of the target low power state device node when a mesh network was established.

8. A system for relaying energy to other device nodes, the system comprising:
a device node having:
a processor;
at least dual antennas to receive and transmit energy; and
a storage device to store energy received via the dual antenna, wherein the device node is to receive a communication signal directing the device node to relay the stored energy to a target low power state device node to actuate the target low power state device node into a higher power state, wherein the processor is to cause the dual antenna to transmit the stored energy to the target low power state device node.

9. The system of claim 8 wherein the energy received is from a reflected energy device.

10. The system of claim 9 wherein the node device is within an aggregated node group that reflects the energy to indicate a plurality of device nodes actuated into a higher power state and non-actuated low power state device nodes.

11. The system of claim 8 further comprising an intelligence engine to cause transmission of the communication signal.

12. A computer program product including a non-transitory computer readable storage medium having executable code, the code when executed by a processor to be adapted to cause a node device to:
receive relay energy for storage;
store the received relay energy;
receive a communication signal to direct the device node to relay the stored relay energy to a low power state device node; and
transmit the stored relay energy to the low power state device node to transition the low power state device node into a higher power state.

13. The computer program product of claim 12 wherein the relay energy is from a reflected energy device.

14. The computer program product of claim 12 wherein the communication signal is caused by an intelligence engine communicably coupled to the reflected energy device.

15. The computer program product of claim 12 wherein the device node is a neighboring device node of the low power state device node.
